(19) United States
(12) Patent Application Publication
(10) Pub. No.: US 2006/0184704 A1
(43) Pub. Date: Aug. 17, 2006

(54) Balanced technology extended (BTX) motherboard assembly

(75) Inventor: Hsiang-Lung Yu, Ta-Li City (TW)

Correspondence Address: DLA PIPER RUDNICK GRAY CARY US, LLP, 2000 UNIVERSITY AVENUE, E. PALO ALTO, CA, 94303-2248, US

(73) Assignee: Universal Scientific Industrial Co., Ltd.

(21) Appl. No.: 11/060,194

(22) Filed: Feb. 17, 2005

(51) Int. Cl. G06F 13/00

(52) U.S. Cl. 710/300

(57) ABSTRACT

A Balanced Technology Extended (BTX) motherboard assembly includes a motherboard, first and second expansion slots provided on the motherboard, and a riser card. The motherboard complies with the Balanced Technology Extended (BTX) specification. The first expansion slot complies with the Peripheral Component Interconnect Express (PCIE) specification. The second expansion slot complies with the PCIE specification. The riser card is connected removably to the second expansion slot and is formed with a plurality of expansion slots.

### BACKGROUND OF THE INVENTION

1. Field of the Invention

The invention relates to a motherboard assembly, more S particularly to a motherboard assembly that complies with a small Balanced Technology Extended specification.

2. Description of the Related Art

Those skilled in the art of computer-related fields are aware that there are two dominant specifications for computer motherboards: one is Advanced Technology Extended (ATX) specification; the other is Balanced Technology Extended (BTX) specification. Whether it is an ATX motherboard or a main-stream BTX motherboard, the conventional computer motherboard suffers from a drawback: the dimensions of the board body thereof are relatively large, and hence the size of a computer housing to enclose the same is difficult to be minimized. Motherboards complying with the BTX specification can be further subcategorized according to dimensions: the first type is a BTX motherboard, which has a size of 10.5 inches×12.8 inches, and up to 7 expansion slots that comply with the Peripheral Component Interconnect (PCI) specification; the second type is a micro-BTX (μBTX) motherboard, which has a size of 10.5 inches×10.4 inches, and up to 4 expansion slots that comply with the PCI specification; the third type is a pico-BTX motherboard, which has a size of 10.5 inches×8 inches, and only one expansion slot that complies with the Peripheral Component Interconnect Express (PCIE) specification. Although the aforesaid pico-BTX motherboard has the S smallest dimensions, the pico-BTX motherboard only has one expansion slot that complies with the PCIE specification. As such, it can only be used for a special-purpose computer with a small-size computer housing, and cannot be used for a general-purpose computer.

Moreover, the μBTX motherboard in general includes only one PCIE×16 expansion slot and up to 3 PCI or PCIE expansion slots, wherein the PCIE×16 expansion slot is specially designed for a graphics card that complies with a new generation of PCIE specification. Referring to FIG. 1, a conventional μBTX motherboard 1 includes a board body 11, a pair of PCI expansion slots 12, 13, a PCIE×1 expansion slot 14, a PCIE×16 expansion slot 15, an I/O interface 16, an I/O controller 17, a graphic memory controller 18, and a central processing unit 19. The PCI expansion slots 12, 13 can be used for insertion of two interface cards complying with the PCI specification (not shown in the Figure). The PCIE×1 expansion slot 14 can be used for insertion of interface cards complying with the PCIE×1 specification (not shown in the Figure). The PCIE×16 expansion slot 15 can be used for insertion of a graphics card complying with the PCIE×16 specification (not shown in the Figure). The board body 11 has a length 101 of 10.5 inches, and a width 102 of 10.4 inches.

As described in the foregoing, since the μBTX motherboard 1 is designed to have up to four expansion slots complying with the PCI-associated specifications, a size of 10.5 inches×10.4 inches for the board body 11 is required, which has an adverse affect to miniaturization of the computer housing.

### SUMMARY OF THE INVENTION

Therefore, the main object of the present invention is to provide a motherboard assembly that comply with the Balanced Technology Extended specification, and that can overcome the aforesaid drawbacks associated with the prior art.

According to one aspect of the present invention, there is provided a Balanced Technology Extended (BTX) motherboard assembly that comprises a motherboard, a first expansion slot and a second expansion slot.

The motherboard complies with the Balanced Technology Extended (BTX) specification.

The first expansion slot complies with the Peripheral Component Interconnect Express (PCIE) specification, is provided on the motherboard, and is adapted to be connected to a graphics card.

The second expansion slot complies with the PCIE specification, and is provided on the motherboard.

According to another aspect of the present invention, there is provided a BTX motherboard assembly that comprises: a motherboard complying with the Balanced Technology Extended (BTX) specification; a first expansion slot complying with the Peripheral Component Interconnect Express (PCIE) specification, provided on the motherboard, and adapted to be connected to a graphics card; a second expansion slot complying with the PCIE specification and provided on the motherboard; and a riser card connected removably to the second expansion slot and formed with a plurality of expansion slots that comply with PCI-associated specifications.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic block diagram of a conventional micro Balanced Technology Extended (μBTX) motherboard;

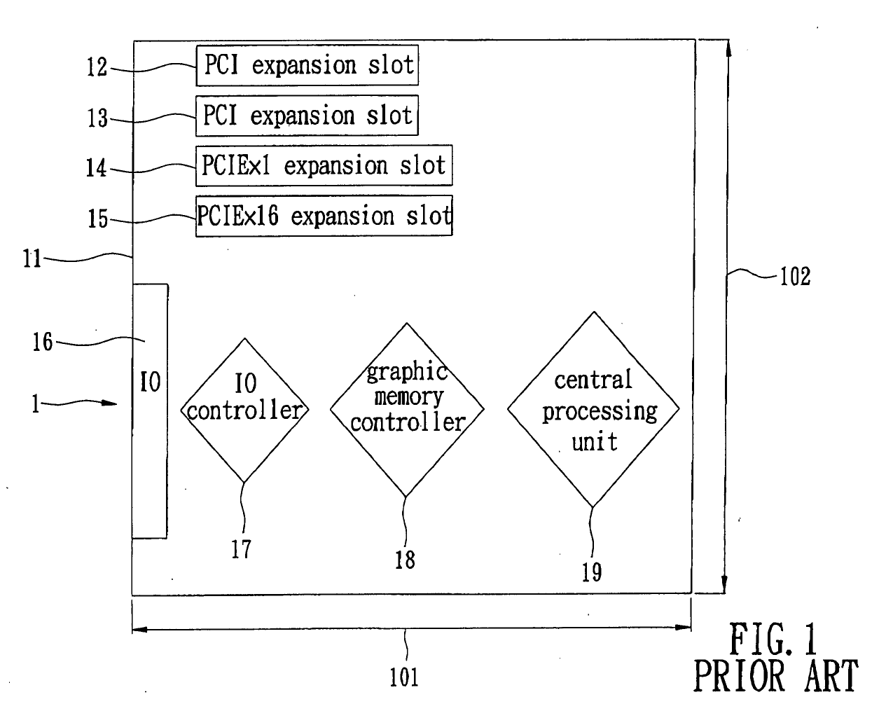

FIG. 2 is a schematic block diagram of a preferred embodiment of a Balanced Technology Extended motherboard according to the present invention; and

FIG. 3 is a schematic block diagram of a riser card used in the preferred embodiment.

### DETAILED DESCRIPTION OF THE PREFERRED EMBODIMENT

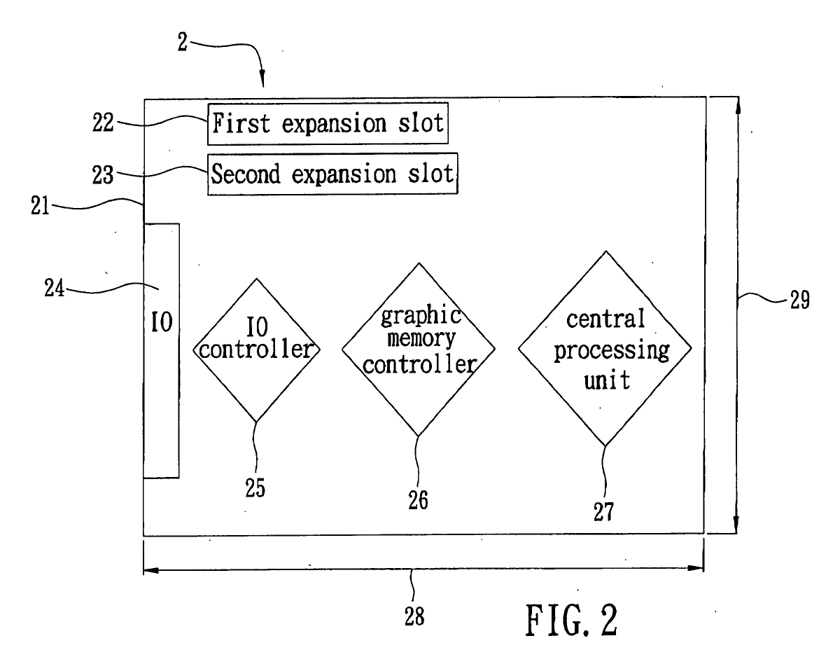

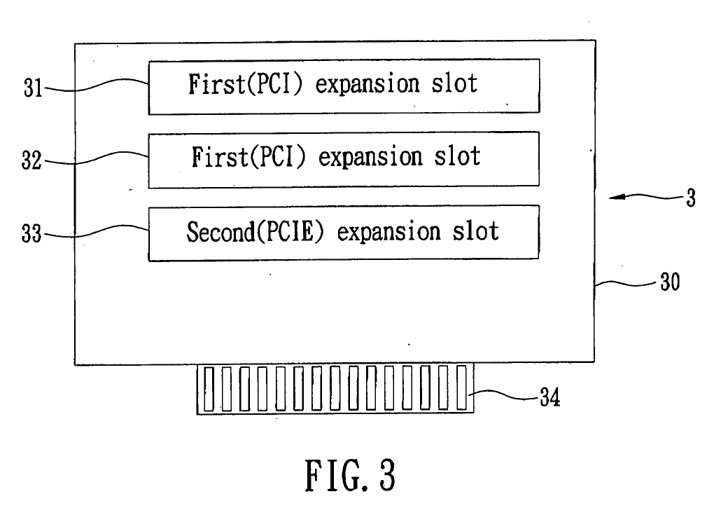

Referring to FIGS. 2 and 3, the preferred embodiment of a Balanced Technology Extended (BTX) motherboard assembly 2 according to the present invention is shown to include a motherboard 21, a first expansion slot 22, a second expansion slot 23, an I/O interface 24, an I/O controller 25, a graphic memory controller 26, a central processing unit 27, and a riser card 3.

Since the I/O interface 24, the I/O controller 25, the graphic memory controller 26 and the central processing unit 27 are well known to those skilled in the art, and since the improvement of this invention is not directed to the same, so they will not be detailed further for the sake of brevity.

The first expansion slot 22 is provided on the motherboard 21, is adapted to be connected to a graphics card (not shown), and complies with the Peripheral Component Interconnect Express (PCIE) specification, such as the PCIE×16 specification.

The second expansion slot 23 is provided on the motherboard 21, also complies with the PCIE specification, such as the PCIE×16 specification, and is adapted for connection to the riser card 3.

Referring again to FIG. 3, the riser card 3 is shown to include a board body 30, an expansion slot unit having a pair of first expansion slots 31, 32 and a second expansion slot 33, and a goldfinger unit 34.

The first expansion slots 31, 32 of the riser card 3 are formed on the board body 30, and comply with the PCI specification.

The second expansion slot 33 is formed on the board body 30, and complies with the PCIE specification, which can be PCIE×1, PCIE×4, or PCIE×8 specification.

The goldfinger unit 34 is formed on the board body 30, is formed with a plurality of conductive traces, and is adapted to be inserted into the second expansion slot 23 of the motherboard 2.

Although the motherboard 21 is provided with only two expansion slots, i.e., the first and second expansion slots 22, 23, the motherboard 21 can be connected to a plurality of interface cards that comply with specifications, including PCI, and PCIE×1, PCIE×4, or PCIE×8 specifications, through insertion of the riser card 3 into the second expansion slot 23 on the motherboard 21.

Since the motherboard 21 only has the first and second expansion slots 22, 23 that comply with the PCIE specification, the size of the motherboard 21 can be reduced significantly when compared with the conventional μBTX motherboard 1. As shown in FIG. 2, the motherboard 21 of the motherboard assembly 2 has a length 28 the same as the length 101 of the conventional μBTX motherboard 1, that is, 10.5 inches. However, the motherboard 21 of the motherboard assembly 2 has a width 29 much smaller than the width 102 of the conventional μBTX motherboard 1, i.e., 8.8 inches versus 10.5 inches. This results in a 20% reduction in the size of the motherboard 21 of the motherboard assembly 2 when compared with the conventional μBTX motherboard 1.

In sum, the motherboard assembly 2 of this invention has a significant reduction in size when compared with the conventional μBTX motherboard 1, while maintaining flexibility of interface expansion by virtue of the riser card 3.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A Balanced Technology Extended (BTX) motherboard comprising:
a motherboard complying with the Balanced Technology Extended (BTX) specification;
a first expansion slot complying with the Peripheral Component Interconnect Express (PCIE) specification, provided on said motherboard, and adapted to be connected to a graphics card; and
a second expansion slot complying with the PCIE specification and provided on said motherboard.

2. The motherboard of claim 1, wherein the size of said motherboard is 10.5 inches×8.8 inches.

3. The motherboard of claim 1, wherein each of said first and second expansion slots complies with PCIE×16 specification.

4. A Balanced Technology Extended (BTX) motherboard assembly comprising:
a motherboard complying with the Balanced Technology Extended (BTX) specification;
a first expansion slot complying with the Peripheral Component Interconnect Express (PCIE) specification, provided on said motherboard, and adapted to be connected to a graphics card;
a second expansion slot complying with the PCIE specification and provided on said motherboard; and
a riser card connected removably to said second expansion slot and formed with a plurality of expansion slots that comply with PCI-associated specifications.

5. The motherboard assembly of claim 4, wherein the size of said motherboard is 10.5 inches×8.8 inches.

6. The motherboard assembly of claim 4, wherein each of said first and second expansion slots complies with PCIE×16 specification.

7. The motherboard assembly of claim 4, wherein at least one of said PCI-associated specification expansion slots complies with PCI specification.

8. The motherboard assembly of claim 4, wherein one of said PCI-associated specification expansion slots on said riser card complies with PCIE specification.

9. The motherboard assembly of claim 4, wherein at least one of said PCI-associated specification expansion slots complies with PCI specification, and one of the remainder of said PCI-associated specification expansion slots on said riser card complies with PCIE specification.

10. A Balanced Technology Extended (BTX) motherboard comprising:
a motherboard complying with the Balanced Technology Extended (BTX) specification; and
an expansion slot unit that is provide on said motherboard and that consists of
a first expansion slot complying with the Peripheral Component Interconnect Express (PCIE) specification, and adapted to be connected to a graphics card, and
a second expansion slot complying with the PCIE specification.

11. The motherboard of claim 10, wherein the size of said motherboard is 10.5 inches×8.8 inches.

12. The motherboard of claim 10, wherein each of said first and second expansion slots complies with PCIE×16 specification.
